(19) United States
(12) Patent Application Publication
(10) Pub. No.: US 2002/0038450 A1
(43) Pub. Date: Mar. 28, 2002

(54) Method and system to run stored procedures as workflow activity implementations

(75) Inventors: Matthias Kloppmann, Sindelfingen (DE); Frank Leymann, Aidlingen (DE); Dieter Roller, Schoenaich (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/920,218

(22) Filed: Aug. 1, 2001

(30) Foreign Application Priority Data
Aug. 3, 2000 (EP) 00116774.1

(51) Int. Cl. G06F 9/44

(52) U.S. Cl. 717/102

(57) ABSTRACT

A technique for the construction, management, and execution of workflow-based applications consists of at least a development environment for process-based applications (DEPBA), a Workflow Management System (WFMS) and a Database Management System (DBMS). The WFMS provides for the definition and execution of process models underlying the workflow-based applications. The DBMS provides support for definition and execution of components, in particular stored procedures, that implement activities within the process model. The DEPBA provides for the definition of workflow-based applications and the export/import of the appropriate definitions to/from the WFMS and the DBMS. The technique shows how (1) the information required by the WFMS to run a component managed by the DBMS can be obtained by extracting the appropriate metadata for the component from the DBMS and (2) the information about a process step in a process model managed by the WFMS intended to be implemented as a component can be transformed into metadata associated with that component and transferred to the DBMS.

### BACKGROUND OF THE INVENTION

1. Field of the Invention

The present invention, in general, relates to the field of application construction based on stored components, e.g., on stored procedures. More specifically, the invention concerns a method and a system for developing process-based applications, in particular workflow-based applications, using a development environment for process-based applications, the process-based applications being based on at least one process model containing at least one process step that is performed by at least one component hosted by a database management system and represented by metadata managed by the database management system.

2. Description of the Related Art

Component-based application construction is a major industry trend which two major ingredients are components and a scripting language. Components are discrete functions, in particular business functions, that can be reused in many different (business) situations. Process models are one kind of scripting language prescribing aspects of so-called “component choreography” like the potential invocation sequence of the components. The components are then referred to as “activity implementations”.

Workflow-based applications consist of one or more process models and the corresponding collection of activity implementations. Running such an application means that the appropriate workflow management system (WFMS) instantiates a process model into a running workflow and carries out the process model(s) and invokes the appropriate activity implementations. Hereto it is briefly referred to FIG. 1 which depicts a WFMS environment and a process model which consists of individual process steps called “activities”. These activities are implemented by some components often called “activity implementations”. These activity implementations are defined via a development environment for process-based applications, whereby their execution is managed by the WFMS.

There are many ways of implementing an activity, such as DLLs and EXEs. One particular way of implementing an activity are components that are carried out by a database management system (DBMS). In this case, the DBMS provides an execution environment for those components. A particular implementation of a component that is managed by a DBMS are stored procedures.

Business process modelers typically use a development environment to build workflow-based applications. One of the activities is to define the properties of the stored procedures that are to be used as activity implementations. The WFMS needs this information so that it can invoke the stored procedures properly when the business processes are being carried out.

The development environment could be anything from a very sophisticated, integrated environment to a very rudimentary text editor. It could be a business engineering tool, that can generate the necessary import file for the WFMS to invoke the stored procedures when carrying out the business processes; the buildtime component of the WFMS that carries out the business processes; or a text editor to create a file that contains the appropriate information in an exchange format supported by the WFMS.

For all approaches, the definition of the information to use stored procedures as activity implementations are a very cumbersome, time consuming and error-prone endeavor.

### SUMMARY OF THE INVENTION

The object to be solved by the present invention is to provide a method and a system that facilitates the usage of stored procedures as components for a process-based, in particular workflow-based, application construction.

Another object is to provide a method and a system which help in the construction of stored procedures that are used within process-(workflow-)based applications in an as much as possible fast, reliable and convenient manner.

The above objects are solved by the features of the independent claims. Advantageous embodiments are subject matter of the subclaims.

The proposed method and system allow to derive from a DBMS hosting the stored procedures all the metadata required by the WFMS to run a stored procedure as an activity implementation, feed it into a development environment for the process-based application (DEPBA), create the workflow-based application in the DEPBA, if necessary, and move the metadata, such a signature and location information of the stored procedure, required by the WFMS to carry out the stored procedure into WFMS.

It is noteworthy hereby that the invention relates to any kind of execution environment comprising procedures and their accompanying and describing metadata. Such execution environments are realized, for instance, as database management systems or transaction management systems or the like. Process models according to the invention include those process models serving for descriptive purposes only as well as such process models which can be executed actively like a WFMS.

According to another aspect of the invention, a further method is proposed which is reverse to the aforementioned method. The description of the process models in an WFMS usually contains the definition of the individual activities, which includes their signatures and designated implementation. The proposed system and method accesses these metadata to extract the information needed to derive the appropriate definitions for the stored procedures that implement the activities, feed it into the DEPBA, create the workflow-based application, if necessary, create the appropriate metadata for the stored procedures, and move this information to the DBMS.

The invention allows application construction at a much faster pace. Available stored procedures will be automatically introduced as possible activity implementations and an automatic update of information about newly available stored procedures can be done. Furthermore, database programmers will be able to automatically derive all necessary information about activities that might be candidates for implementations via stored procedures. This will facilitate a much faster development of complete process-based applications.

It is emphasized hereby that the DEPBA and the interactions between the DEPBA and the WFMS and DBMS are only conceptual; they do not assume any particular implementation. The DEPBA could be implemented as a standalone tool, as part of the WFMS, such as the buildtime component of the WFMS, as part of the DBMS, such as the stored procedure builder of the DBMS, or as a combination thereof. The interaction between the DEPBA could be implemented in many different ways, for example could the DEPBA directly write into the metadata store of the WFMS and DBMS.

### BRIEF DESCRIPTION OF THE DRAWINGS

The invention will be understood more readily from the following detailed description when taking in conjunction with the accompanying drawings, in which:

FIG. 1 is a schematic block diagram depicting a method of process-based application construction according to the prior art;

FIG. 2 shows the structure of a process-based application consisting of one or more process models according to the prior art;

FIG. 3 is a block diagram depicting a database management system, a development environment for process-based applications and a workflow management system according to the present invention; it also shows the process of extracting metadata for stored procedures and transferring it into definitions suitable for usage in a development environment for process-based applications;

FIG. 4 is a block diagram similar to FIG. 3, in order to illustrate the method for generating stored procedures in a database management system based on metadata retrieved from a development environment for process-based applications according to the invention;

FIG. 5 is a flow chart depicting a method for extracting metadata about stored procedures and transferring it into a development environment for process-based applications according to the invention;

FIG. 6 is another flow chart depicting generation of stored procedures based on metadata retrieved from a development environment for process-based applications in accordance with the invention; and

FIG. 7 is a flow chart showing an embodiment of an automatic information retrieval system for use in a development environment for process-based applications according to the invention.

### DESCRIPTION OF THE PREFERRED EMBODIMENT

The following description is based on a database management system (DBMS) invoking stored components, in particular stored procedures. However, the same principles apply for any transaction-processing (TP) monitor (according to the OSI model) invoking application programs, as long as those application programs are described to the TP monitor using metadata, and as long as that TP monitor allows for external access to those metadata.

Also, whenever the term “stored procedure” is mentioned, it is more generally understood “stored component” which might also be any other type of executable a DBMS can execute, e.g., an Enterprise JavaBeans (EJB) running on an EJB Java application server. Java is a trademark of Sun Microsystems, Inc.

Further it should be noted that it is made no assumption how a development environment for process-based applications (DEPBA) is implemented, as indicated within the text, since it can be implemented several different ways.

Further, a workflow-based application, in the following context, is an application that consists of at least one process model where at least one of the steps is represented by at least one of the components managed by the DBMS. The components are identified to the DBMS via metadata such as signature information or topology information required to locate the component when carrying it out. The process models are identified to the WFMS via metadata such as the structure of the process model, the individual steps that make up the process model, and the linkage to the components that implement the individual steps.

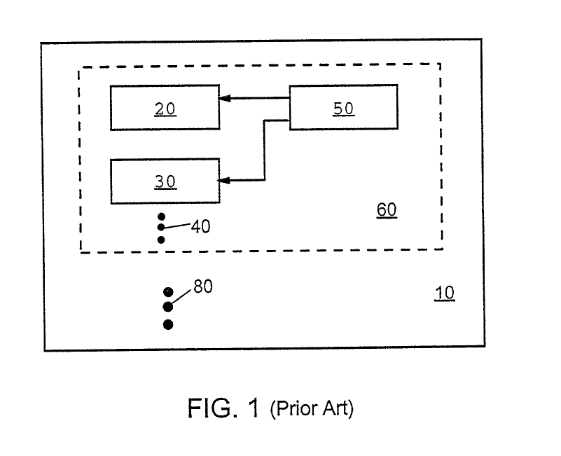

The block diagram depicted in FIG. 1 shows a data structure of a process-based application 10 according to the prior art. The application 10 is comprised of a number of components 20, 30 and may be of further components 40 not shown here. Running the application 10, the components 20, 30 are acting or interacting by means of a scripting language 50. The components 20, 30, in the present embodiment, are discrete business functions that can be reused in many different business situations while the components 20, 30 are created by using a programming language. In its broadest sense, components can be any reusable asset.

The scripting language 50 is used to prescribe how to deploy the components 20, 30. Depending on the granularity of the components 20, 30, the appropriate scripting language 50 must be chosen. One kind of scripting language 50 prescribing aspects of the actions and interactions of components (component choreography) like the potential invocation sequence of the components, are so called process models. The components 20, 30 as used by the respective scripting language 50 are then referred to as activity implementations. As an application most cases consist of more than one process model, the application 10 can be comprised of a collection of process models depicted in the FIG. 1 as dots 80.

A workflow management system environment running the application 10 means to instantiate a process model 60 which is a collection of activity implementations together with a processing specification like scripting language 50 into a running workflow. The underlying workflow system interpretes the process model(s) and invokes the process models 60, i.e., the components 20, 30, at runtime according to the actual context associated with the workflow.

Referring again to FIG. 1, in a WFMS environment, a process model consists of individual process steps called “activities”. These activities are implemented by some components often called “activity implementations”. These activity implementations are defined via a development environment for process-based applications, whereby their execution is managed by the WFMS.

The following particular implementation of components is only used to illustrate the proposed method and system. However this does not restrict the applicability of the proposed method and system. Any component that is a managed by a DBMS is subject to the proposed method and system. In addition, it is not required that the system is a DBMS in the narrow sense; it can be any system that provides for the persistence of data and the support of execution of components defined to it. In fact, it could apply to any system that manages the execution of components.

The stored procedures are made known to the DBMS via a registration process that stores all relevant information that the DBMS needs to carry out a stored procedure (not shown in FIG. 1). It is noteworthy hereby that the DBMS only contains the stored procedure relevant metadata, but not the process model metadata which is managed by the WFMS.

A stored procedure is an executable that is hosted by a database system, that means the database system provides the runtime environment for this kind of executable. Nowadays, most of the known DBMSs support stored procedures. To be able to carry out the stored procedure, the DBMS needs to maintain appropriate information (metadata), such as the signature (input and output parameters) of the stored procedure or the location where the underlying code of the stored procedure is stored. Invocation of stored procedures, such as via WFMSs, is by calling the DBMSs with the appropriate informations, such as the parameters to be passed into the stored procedure.

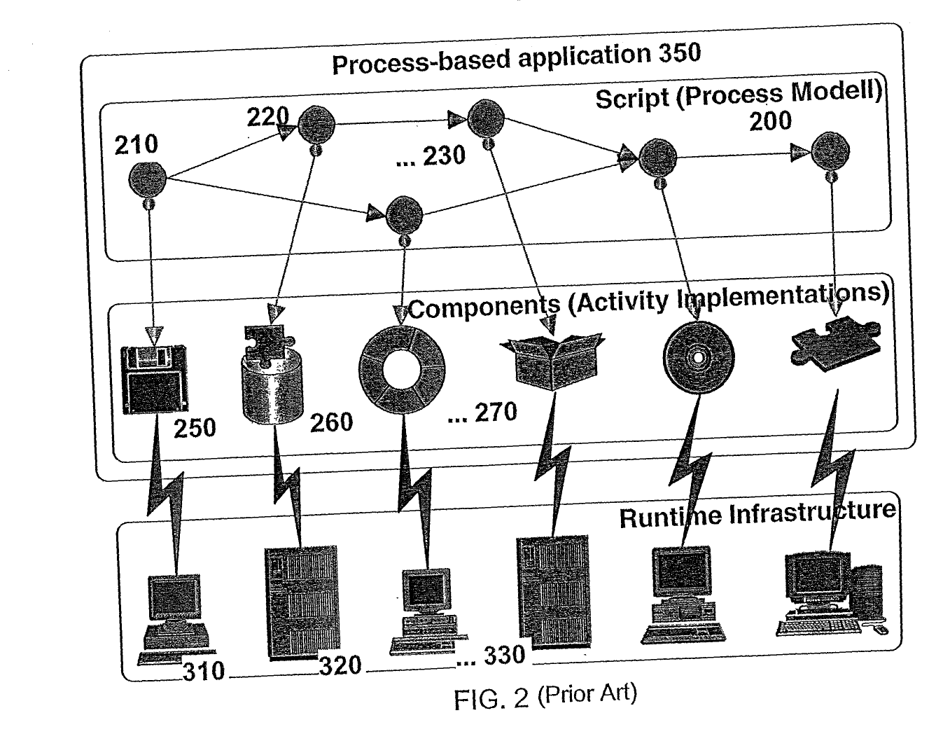

The block diagram depicted in FIG. 2 shows the structure of a process-based application 350 according to the prior art. consisting of one or more process models 200, which consists of multiple steps 210, 220, 230, the activities, which in turn are implemented by the activity implementations 250, 260, 270. Each of the activity implementations is run on an associated runtime infrastructure 300, 310, 320. The invention particularity concerns activity implementations that are stored procedures, and runtime infrastructures that are DBMSs.

The script 200 is used to prescribe in which order the components 250, 260 should be invoked. Depending on the granularity of the components 250, 260, the appropriate type of script must be chosen. One kind of scripts prescribing aspects of the actions and interactions of components (component choreography) like the potential invocation sequence of the components, are so called process models. The components 250, 260 as used by the script are then referred to as activity implementations. As an application mostly consists of more than one process model, the application 350 can be comprised of a collection of process models (not shown in FIG. 2).

A workflow management system environment running the application 350 means to instantiate an executable version of the process model into a running workflow. The underlying workflow system interpretes the process model(s) and invokes the components 250, 260 at runtime according to the actual context associated with the workflow.

Building such a process model is done by means of a development environment for process-based applications. The development environment could be anything from a very sophisticated, integrated environment to a very rudimentary text editor.

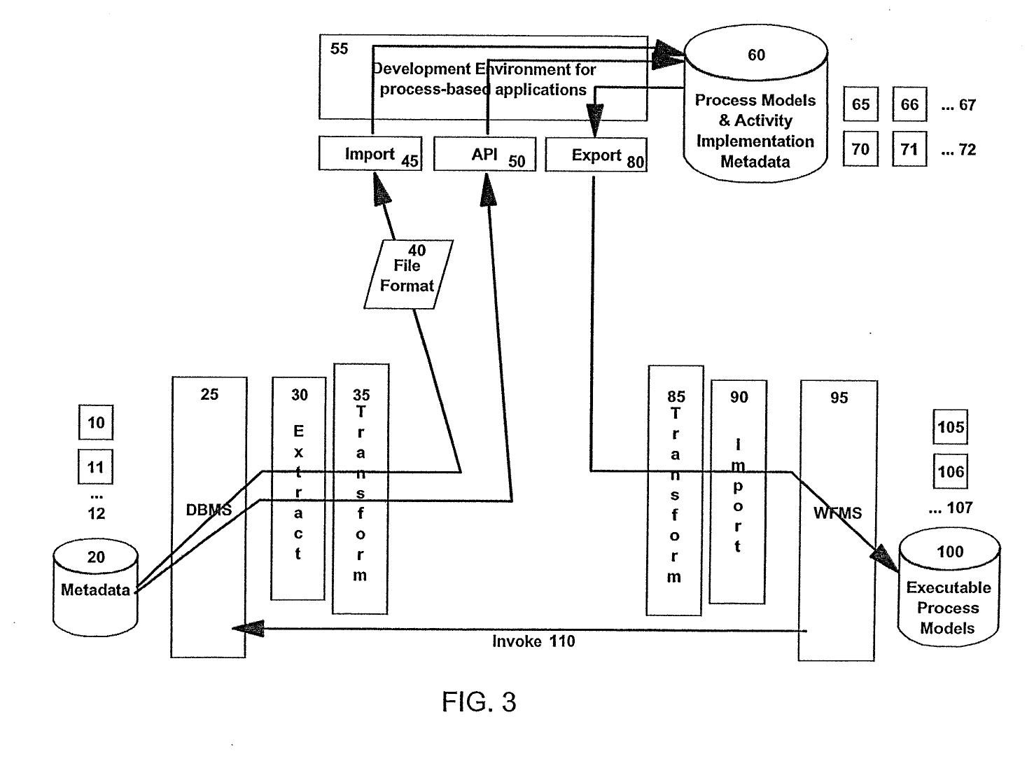

FIG. 3 schematically shows a system for managing workflow-based applications consisting of a workflow management system 95 (in the following designated WFMS), a database management system 25 (in the following referred to as DBMS) and a development environment for process-based applications 55 (in the following designated as DEPBA). An exemplary workflow management system which can be used in the present context is the MQSeries Workflow of the present applicant. Accordingly, a usable database management system is the system DB2 also developed by the present applicant. MQ Series and DB2 are registered trademarks of IBM Corporation. Likewise, an exemplary development environment is the Build-Time of the aforementioned MQSeries Workflow system. The DBMS 25, which in the present embodiment is a relational database, manages a number of stored components 10, 11 and further components depicted as dots 12 which are executables and can be used as steps in a process-based application, i.e., as activity implementations in a process model.

The DBMS 25 further provides a run time environment for the stored components 10, 11, 12, which are represented by metadata 20. Exemplary metadata 20 can be signature information for each stored component 10, 11, 12, which includes information about the language the stored component is written in, its input and output parameters and their types, etc. Another example for the metadata 20 is topology information required to locate stored components 10, 11, 12. This data is needed for connecting appropriately to the database hosting the stored component, e.g., where to call the stored component like the server name, the database name, or the instance.

FIG. 3 further depicts a method for extracting information needed by a development environment for process-based applications 55 in order to develop an application based on one or more process models (stored in any kind of data store 60 of the development environment), with the goal of running it by a WFMS 95. An extraction component 30 obtains all the necessary metadata from a database system that stores its metadata in an appropriate data store 20 which is managed by the DBMS 25. The extraction component 30 which is specific to the DBMS 25 extracts from the metadata store 20 signature information for each stored component 10, 11, 12 as well as topology information required to locate the stored components. The extraction component 30 which is specific to the DBMS 25 then passes the extracted information to a transformation component 35 that reformats this information into a data format appropriate for the development environment 55, i.e., a format which can be processed by or is compatible to the development environment 55. The reformatted information is then transferred to the development environment 55.

It should be mentioned that the transformation component 35 is specific to the respective development environment 55 insofar as it has to provide a suitable workflow definition interchange format file 40. In the present embodiment, the transformation component 35 generates an FDL file which is a workflow specific exchange format of the already mentioned MQSeries Workflow system and its Build Time.

An importation component 45 then imports the transfer format instance 40 into the development environment which stores its process models in the data store 60 and which is an MQSeries Workflow in the present embodiment. Alternatively, the transformation component 35 might use corresponding APIs 50 (Application Programming Interfaces) provided by the development environment 55.

It is noted hereby that the standardized exchange format of the known workflow management coalition (WfMC) can be used to make the transformation component 35 and/or the extraction component 30 independent of the respective underlying development environment 55. Other file formats that could be used include the SLANG format from Microsoft Corp.

Finally, in order to deploy the workflow-based application to a WFMS 95, it has to be exported from the development environment 55, transformed into a format suitable for the WFMS by a transformation component 85 and imported into the WFMS by means of an import component 90, which stores the process model and associated metadata describing the activity implementations as executable process models 105, 106, 107 in a suitable data store 100. During execution of the workflow-based application, the WFMS 95 invokes an activity implementation represented by a stored component 10 hosted by the DBMS 25 by sending an appropriate invocation request to the DBMS, using the metadata made available by the development environment 55 through the extraction and transformation steps described above.

According to another aspect of the present invention, a mechanism is proposed by which, based on a process model 65 containing one or more activities (here not shown), implementations 70, 71, 72 of the activities are automatically generated and the corresponding stored procedures 10, 11, 12 created in DBMS. Hereby the process model remains in the development environment. The further details of the construction of stored procedures 10-12 that implement activities in workflow 65 are described in more detail in the following.

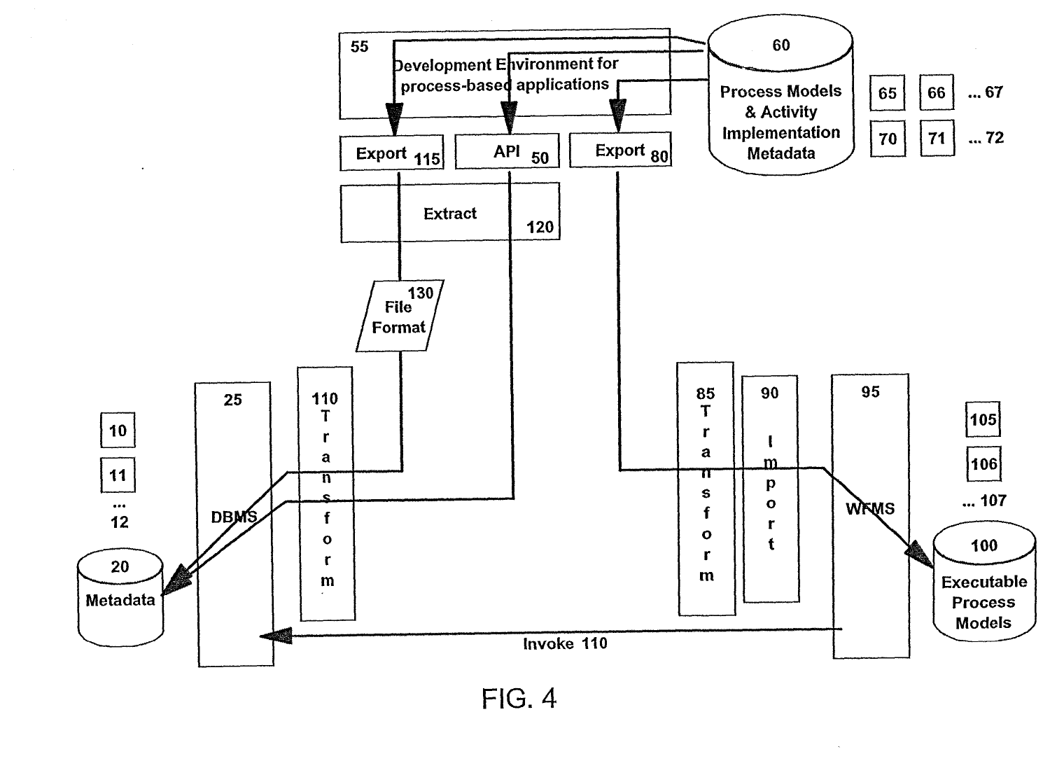

FIG. 4 shows a block diagram similar to FIG. 3 depicting another method according to the invention for providing definitional data for stored procedures for individual activity implementations of a process model used by a WFMS 95. In this figure, entities that are the same as in FIG. 3 have the same identification numbers.

It is hereby assumed that, in accordance with FIG. 3, the process models are stored in a data store 60 connected to the development environment 55. The description of the process models in the development environment 55 contains the definition of the individual activities, which includes their signatures and designated implementation.

The mentioned metadata are accessed in order to extract the information needed to derive the required definitional data for the stored procedures that implement the activities. This required information is extracted from the development environment 55 process model data store 60. This can be either done via exporting a transfer format instance 40, (e.g., an FDL file) by means of an exportation component 115 and via an extraction component 120. Alternatively, exportation of the metadata can be accomplished by means of an API 50 which is specific for the respective development environment 55. The information is then passed to a transformation component 110 which generates stored procedure definitions and transfers them to a DBMS 25. The DBMS 25 then stores the stored procedure definitions into its metadata store 20.

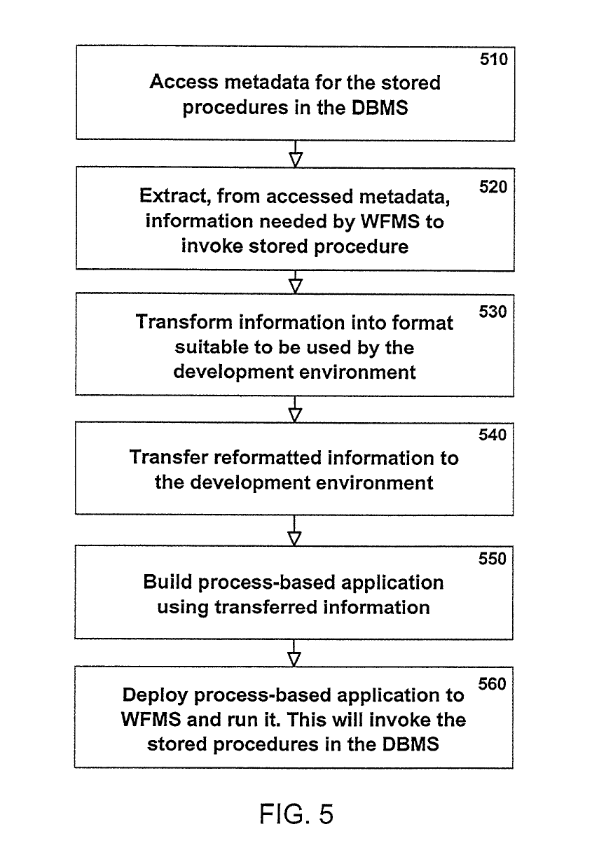

The mechanism shown in FIG. 3 is now described in more detail with reference to the flowchart depicted in FIG. 5. It is assumed now that a workflow system (in the following WFMS) is going to run a process-based application, e.g., a business process or workflow application, which is based on one or more process models whereby one or more of the corresponding process steps is implemented by one or more stored procedures stored in a database system (in the following DBMS). It is further assumed that a development environment for process-based applications (DEPBA) is used to build that process-based applications. The run time environment for these procedures is at first accessed by way of metadata stored in the DBMS (Step 510). From the accessed metadata, information needed by the WFMS to run the application, and thus also needed by the DEPBA, is extracted (Step 520). This can be done by way of a SQL (Simple Query Language) statement or any other applicable extracting method. The extracted information is then reformatted into a suitable transfer format which can be processed by the DEPBA (Step 530). Then this reformatted information is transferred to the DEPBA (Step 540). The reformatted information is then used by the DEPBA to make the stored procedures known to the DEPBA as activity implementations, such that they can readily be used by a process modeller to incorporate them into a process-based application (Step 550). Finally, such an application will be deployed to a WFMS, and its execution will ultimately use the metadata to invoke the stored procedures in the DBMS (Step 560).

In the following, an exemplary embodiment of a signature derivation using a DB2 catalog is depicted. In particular, it is described how to obtain a signature of stored procedures out of DB2. A SQL (Structured Query Language) and the DB2 catalog are used for this purpose. Because SQL and views on catalogs of relational database systems are standardized, this is to a certain degree applicable to other DBMS platforms.

The following SQL statement can be used by the extract component to select the signature of all stored procedures defined within a certain database:

SELECT S.PROCSCHEMA, S.PROCNAME, LANGUAGE, PARMNAME,

| | |
|---|---|
| TYPESCHEMA, TYPENAME, LENGTH, SCALE, PARM_MODE | FROM |
| SYSIBM.SYSPROCEDURES S, SYSIBM.SYSPROCPARMS P | WHERE |

S.PROCSCHEMA = P.PROSCHEMA

| | |
|---|---|
| AND | S.PROCNAME = P.PROCNAME |
| ORDER BY | S.PROCSCHEMA, S.PROCNAME |

If the signature of a particular stored procedure should be retrieved the following SQL statement can be applied:

SELECT S.PROCSCHEMA, S.PROCNAME, LANGUAGE, PARMNAME,

| | |
|---|---|
| TYPESCHEMA, TYPENAME, LENGTH, SCALE, PARM_MODE | FROM |
| SYSIBM.SYSPROCEDURES S, SYSIBM.SYSPROCPARMS P | WHERE |

S.PROCSCHEMA = P.PROSCHEMA

| | |
|---|---|
| AND | S.PROCNAME = P.PROCNAME |
| AND | S.PROCSCHEME = :schema_name |
| AND | S.PROCNAME = :proc_name |

This information is used by the transformation component to create an FDL file that can be imported into MQSeries Workflow Build Time, for example.

The following depicts sample FDL snippets created for a stored procedures named good_places( ) that takes a date as input and suggest an address where to enjoy at that date as output; note, that the marked keywords are sample extensions required for FDL:

| PROGRAM ‘Good_Places’ | | |
|---|---|---|
| (‘Date’, ‘Address’) | | |
| PROGRAM_EXECUTOR ‘STP_PES1’ | <<<<<< | |
| DATABASE DB2 ‘ADDRESS_DB’ | | <<<<<< |
| STP_NAME ‘GOOD_PLACES’ | <<<<<< | |
| END ‘Good_Places’ | | |
| STRUCTURE ‘Date’ | | |

‘Month’: STRING;
‘Day’: STRING;
‘Year’: STRING;

END ‘Date’
STRUCTURE ‘Address’

‘City’: STRING;
‘Country’: STRING;

END ‘Address’

In the following, an exemplary embodiment of a topology derivation using a DB2 directory is depicted. In particular, it is described how to obtain the topology information about stored procedures out of DB2. It is shown which DB2 commands or administration APIs to use for this purpose. Because such commands and APIs are not subject to standardization the following is highly platform dependent.

The following exemplary pseudo-code provides all information about databases accessible from the current/local node, especially the names of all other nodes on which database are located that are accessible. So, use either the command LIST DATABASE DIRECTORY or the following APIs:

sqledosd( )—open database directory scan

sqledgne( )—get next database directory entry

sqledcls( )—close database directory scan

The following pseudo-code provides all information about how to access the nodes that hold databases accessible from the current/local node, especially their addresses, hosting DB2 instance, etc. So, use either the command LIST NODE DIRECTORY or the following APIs:

sqlenops( )—open node directory scan

sqlengne( )—get next node directory entry

sqlencls( )—close node directory scan

By positioning the corresponding cursors to the actual database and node, all the required information, like instance name, host name, etc., can be derived to connect to the appropriate database at runtime.

The following pseudo-code iterates over all databases in the DB directory, finds the contained stored procedures and the node the respective DB is located on:

sqledosd(“”, dbDirHdl, dbCount)
for i=0 to dbCount do

sqledgne(dbDirHdl, dbName, dbNode, ...)
//Connect to DB and retrieve stored proc
//info as shown above [...]
//Get information about the node that DB is
//located on
sqlenops(nodeDirHdl, nodeCount)
repeat

sqlengne(nodeDirHdl, nodeName, nodeAddr,

nodeProtocol, ...)
until nodeName = dbNode
sqlencls()
//Generate workflow activity implementation
//as shown above [...]
//Generate WFMS topology info based on
//DB placement data
generateFDLforPES(“STP_PESi”, nodeName,
nodeAddr, nodeProtocol)

endfor
sqledcls()

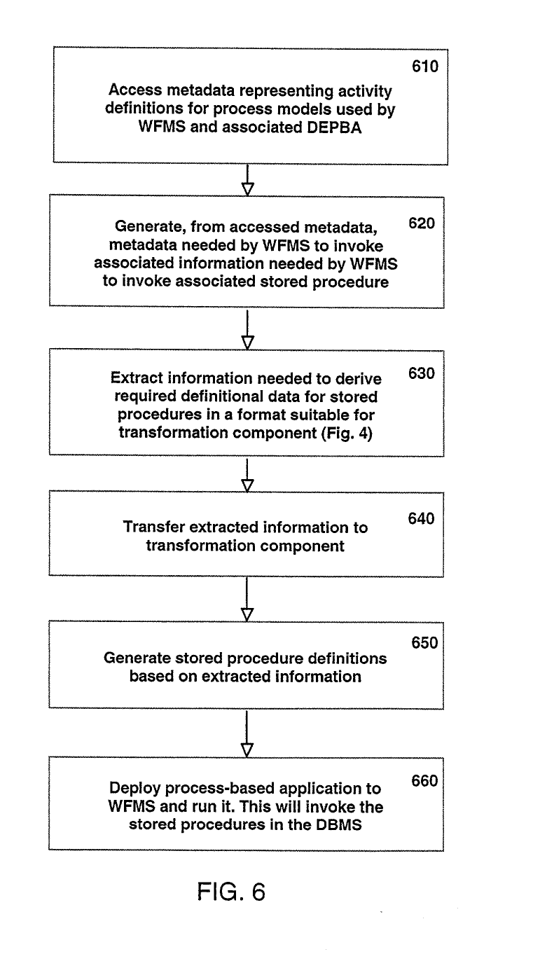

In FIG. 6 the reverse method for generating definitional data for stored procedures that implement activities is depicted in more detail of which basics and methodology have been shown by reference to FIG. 4. At first, metadata which represent definitions of individual activities for process models used by a WFMS and the associated DEPBA are accessed (Step 610). From these accessed metadata, metadata needed by the WFMS to invoke the associated stored procedure is generated (Step 620). Also, information needed to derive the required definitional data for the stored procedures that implement the activities are then extracted in Step 630 in a format suitable for the transformation component shown in FIG. 4 with reference numeral 110. The extracted information thereafter is transferred in Step 640 to that transformation component, which in turn generates stored procedure definitions based on the extracted information (Step 650). This provides the definition of the stored procedure to the DBMS, but of course the actual code must still be written. Using the extracted information, respective stored procedures are defined in Step 650 in the DBMS by issuing respective SQL DDL statements; as part of this, the DBMS inserts the stored procedure definitions into its metadata store. It shold also be noted that there is another insertion path: rather than producing SQL DDL and executing it, input for a development environment for stored components (e.g., the DB2 Stored Procedure Builder) input may be generated, allowing for a seamless integration of the development environment for process-based applications with the development environment for stored components. Finally, in Step 660, the process-based application will again be deployed to the WFMS, and the running workflows will invoke the stored procedures in the DBMS, using the passed metadata.

The following section depicts an exemplary embodiment of the above described reverse method using a DB2. In particular, this section describes how to extract the necessary information from an MQSeries Workflow FDL file and transform it to create the necessary definitions in the DB2 catalog (its metadata store). The information is extracted from MQSeries Workflow Build Time (or any other suitable development environment supporting MQSeries Workflow) using an FDL export function.

Consider the following FDL fragment describing an activity program, together with the associated data structure definitions:

PROGRAM ‘FindGood Places’ (‘Date’,‘Address’)

PROGRAM_EXECUTION_UNIT‘STP_PES1’
DATABASE DB2 ‘ADDRESS_DB’
STP_NAME ‘GOOD_PLACES’

END ‘FindGoodPlaces’
STRUCTURE ‘Date’

‘Month’: STRING;
‘Day’: STRING;
‘Year’: STRING;

END ‘Date’
STRUCTURE ‘Address’

‘City’: STRING;
‘Country’: STRING;

END ‘Address’

From this, the following procedure definition can be derived, assuming that the implementation language is Java:

| | |
|---|---|
| CREATE PROCEDURE GOOD_PLACES | (IN MONTH VARCHAR, |
| | IN DAY VARCHAR, |
| | IN YEAR VARCHAR, |
| | OUT CITY VARCHAR |
| | OUT COUNTRY VARCHAR) |

EXTERNAL NAME ‘good_places.good_places’
LANGUAGE JAVA
PARAMETER STYLE JAVA

The execution of this SQL statement populates the SYSIBM.SYSPROCEDURES and SYSIBM.SYSPROCPARMS tables in the DB2 catalog.

It should also be noted that the same data can be provided as input to DB2's Stored Procedure Builder, to further facilitate creation of the stored procedure's code by the application developer.

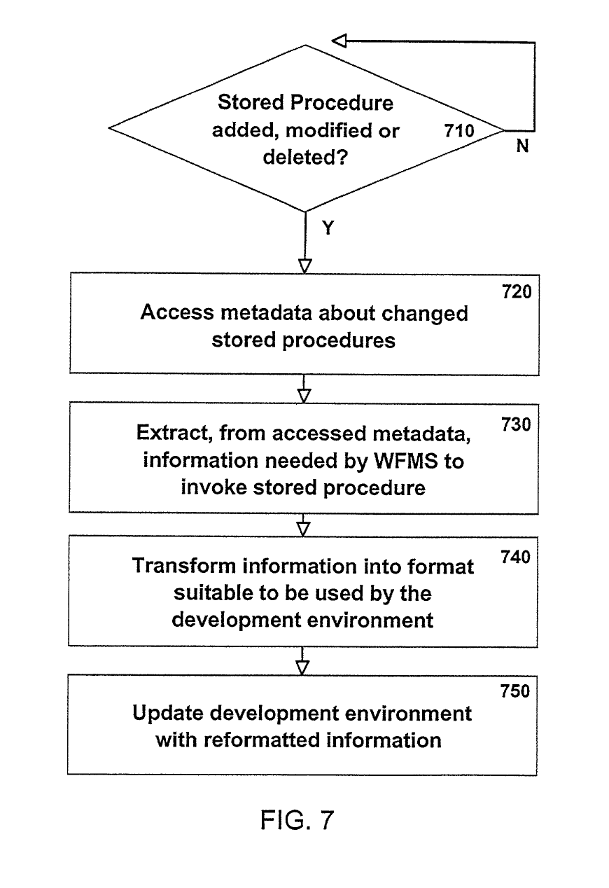

Finally, FIG. 7 shows a flowchart depicting a method according to the invention for continously retrieving changed information about all stored procedures within a network environment and which are accessable from a given network node, in order to keep the DEPBA information up-to-date. This method is commonly designated as “Stored Procedure Crawler”. Using this Stored Procedure Crawler (in the following referred to as “SPC”) the information about available stored procedures within the development environment for process-based applications can be kept up to date. The SPC can be used to initially load the metadata about stored procedures available as activity implementations into the development environment's data store and/or to update the development environment's data store with newly or modified stored procedures available in the network environment after the initial load of the development environment's data store.

At first it is checked in Step 710 whether a stored procedure has been added, modified or discarded. This check can be done in a loop by using a certain time delay or timely triggering the check by using mechanisms provided by the DBMS like triggers. If the check of Step 710 detects that a stored procedure has been added, modified or discarded, metadata for the stored procedure within the network environment is accessed (Step 720) and the metadata required by the WFMS is extracted (Step 730). Thereafter, the retrieved information is reformatted into a suitable format (e.g., an FDL file) (Step 740). The reformatted information is then transferred to the DEPBA and used there to update the available metadata about stored components (Step 750).

The SPC can be started automatically whenever it is detected that a stored procedure is added, modified or discarded within the network environment. This can be achieved by various means, e.g., by replication features of the underlying DBMS which can be used to push information about changes in the set of stored procedures to the DEPBA.

Alternatively, object-relational features can be used like associated corresponding triggers with appropriate catalog tables of the hosting DBMS using a UDF (User Defined Function) to communicate with the DEPBA.

In the following, an exemplary embodiment of an SPC based on DB2 and MQSeries Workflow is depicted. In this embodiment, insert, update and delete triggers are defined on the SYSPROCEDURES as well as the SYSPROCPARMS table:

CREATE TRIGGER stp_modifications
AFTER INSERT ON SYSPROCEDURES
REFERENCING NEW AS n
FOR EACH ROW MODE DB2SQL
BEGIN ATOMIC

VALUES(new_proc_to_wfms(n.PROCSCHEMA,n.PROCNAME,...))

END
CREATE TRIGGER stp_parms_modifications
AFTER INSERT ON SYSPROCPARMS
REFERENCING NEW AS n
FOR EACH ROW MODE DB2SQL
BEGIN ATOMIC

VALUES(new_parms_to_wfms(...,n.TYPENAME,...))

END

The functions invoked by the triggers generate the data in a format appropriate for the DEPBA (e.g. an FDL file), and pass it to the DEPBA for further processing. The required UPDATE and DELETE triggers can be implemented using commonly known programming techniques.

1. A method for developing process-based applications, in particular workflow-based applications, using a development environment for the process-based applications hosted by a process management system, the process-based applications being based on at least one process model containing at least one procedure hosted by an execution environment and represented by metadata, said method comprising the steps of:
accessing the metadata for at least one procedure;
extracting, from the accessed metadata, information needed to run the procedure;
transforming the extracted information into a format appropriate for the development environment for the process-based applications;
transferring the transformed information to the development environment; and
building the application based on the at least one procedure based on the transferred information by moving the stored procedure information to the process management system.

2. The method according to claim 1, wherein the accessed metadata include signatures for the at least one stored procedure stored in a database catalog and topology information stored in a database directory.

3. The method according to claim 1, wherein said extracting step is accomplished by using at least one Simple Query Language (SQL) statement.

4. The method according to claims 1, wherein the process management system is a workflow management system and wherein the development environment is part of the workflow management system.

5. The method according to claim 4, wherein said step of transforming the extracted information is accomplished by reformatting the extracted information into a suitable workflow definition interchange format file, in particular an FDL or WPDL or SLANG format file, and wherein said step of transferring the transformed information is accomplished by transferring the suitable workflow definition interchange format file to the workflow management system.

6. A method for building process-based applications, in particular workflow-based applications, using a development environment for process-based applications, the process-based applications being based on at least one process model containing at least one process step, in particular at least one activity hosted by a process management system, in particular a workflow management system, where at least one of the process steps is to be implemented by at least one stored procedure, said method comprising the steps of:
accessing metadata for the at least one process step in the development environment;
extracting, from the accessed metadata, information needed to derive required definitional data for at least one procedure to be stored;
transforming the extracted information into definitional data for the at least one procedure to be stored; and
creating stored procedure definitions based on the definitional data.

7. The method according to claim 6, further comprising the step of generating at least skeleton information for the at least one stored procedure in a database hosted by a database management system by using the stored procedure definitions.

8. The method according to claim 7, further comprising the step of generating a frame of code for the at least one stored procedure.

9. The method according to claim 6, further comprising the step of inserting the stored procedure definitions into a metadata store hosted by a database management system.

10. The method according to claim 9, wherein the information needed to derive the required definitional data is at least signature information for each stored procedure contained in the metadata store, or at least topology information required to locate stored procedures contained in the metadata store hosted by the database management system.

11. A method for automatically retrieving information about stored procedures contained in a network environment and to be used in a development environment for use in a process management system wherein the procedures are hosted by at least one database management system, said method comprising the steps of:
accessing metadata for at least one of the stored procedures;
extracting, from the accessed metadata, information needed to run the procedure;
transforming the extracted information into a format appropriate for the development environment for process-based applications;
transferring the transformed information to the development environment;
building an application based on the at least one procedure based on the transferred information; and
moving the stored procedure information to the process management system.

12. A method according to claim 11, further comprising the step of, whenever a change in the metadata describing the stored procedures occurs, synchronizing the metadata describing the stored procedures in the DBMS with the information in the development environment.

13. A method according to claim 12, wherein said synchronizing step uses replication features of the database management system to provide information about changes in the stored procedures to the development environment for process-based applications.

14. A method according to claim 11, further comprising the steps of:
determining whether a stored procedure has been added, modified or discarded;
if it is determined in said determining step that a stored procedure has been added, modified or discarded, retrieving information about the stored procedures within the environment;
reformatting the retrieved information into a format read appropriate for the development environment for process-based applications;
transferring the reformatted information to the development environment; and
updating the development environment with the reformatted information.

15. An application development system for developing process-based applications, using a development environment for process-based applications, the process-based applications being based on at least one process model containing at least one stored component hosted by a database management system and represented by metadata stored by the database management system, comprising:
means for accessing the metadata for at least one stored procedure;
means for extracting, from the accessed metadata, information needed to run the stored procedure;
means for transforming the extracted information into a format appropriate for the development environment for process-based applications;
means for transferring the transformed information to the development environment; and
means for building the application based on the at least one procedure based on the transferred information.

16. The system according to claim 15, further comprising means for reformatting the extracted information into a suitable workflow definition interchange format file.

17. An application development system for building process-based applications, using a development environment for process-based applications, the process-based applications being based on at least one process model containing at least one process step, comprising:
means for accessing metadata for the at least one process step in the development environment;
means for extracting, from the accessed metadata, information needed to derive required definitional data for at least one procedure to be stored;
means for transforming the extracted information into definitional data for the at least one procedure to be stored; and
means for creating stored procedure definitions based on the definitional data.

18. An information retrieving system for retrieving information about stored procedures contained in a network environment and to be used by a process management system, wherein the procedures are hosted by at least one database management system, comprising:
means for determining whether a stored procedure has been added, modified or discarded;
means for retrieving information about the stored procedures within the network environment if said determining means has determined that the stored procedure has been added, modified or discarded;
means for reformatting the retrieved information into format read appropriate for the process management system;
means for transferring the reformatted information to the process management system; and
means for updating the process management system with the reformatted information.

19. The system according to claim 18, further comprising:
means for accessing metadata for an added or modified procedure; and
means for extracting, from the accessed metadata, information required by the process management system to run the stored procedure.

20. The system according to claim 18 further comprising means for triggering said determining means to determine whether a stored procedure has been added, modified or discarded.

21. The system according to claim 18, further comprising means for repeatedly executing said determining means after a predetermined time delay.
